(19) United States
(12) Patent Application Publication
(10) Pub. No.: US 2007/0027707 A1
(43) Pub. Date: Feb. 1, 2007

(54) System and methods for interactive selection of a reviewer of media content

(76) Inventors: Frank H. Murray, Greenwich, CT (US); Edward J. Shelton, Stamford, CT (US); Doug Kilzer, New York, NY (US)

Correspondence Address: BROMBERG & SUNSTEIN LLP, 125 SUMMER STREET, BOSTON, MA, 02110-1618, US

(21) Appl. No.: 11/194,747

(22) Filed: Aug. 1, 2005

(51) Int. Cl. G06Q 99/00

(52) U.S. Cl. 705/1

(57) ABSTRACT

Systems and methods for interactively obtaining reviews for media content are disclosed. The systems and methods provide for receiving media content from a reviewee and presenting to the reviewee a plurality of potential reviewers of the media content. The systems and methods also allow the reviewee to select at least one of the plurality of reviewers.

### CROSS REFERENCE TO RELATED APPLICATIONS

This application is related to co-pending U.S. patent application Ser. No. ______, filed on even date herewith and bearing the title, System and Methods for Interactive Evaluation of Media Content, which is hereby incorporated by reference herein in its entirety.

### BACKGROUND

The present invention relates to systems and methods for allowing the interactive evaluation of media content. By way of non-limiting examples, media content may include audio, print, or visual indicia on any medium, songs, albums, poetry, books, art work, television shows, motion pictures, cartoons or any other type of work that may be experienced by another.

Many media content producers often thrive when their works are distributed to a wide group of people. Distribution, however, currently is limited in a number of ways. For example, only a few options exist in the music industry. One option is for the musician to perform live at some public venue, such as subways, street corners, theaters, etc. . . . During these performances, musicians may distribute compact disks or tapes containing their music. Although many musicians have been successful at this type of self-promotion, the odds of succeeding in this manner are strongly against them. For example, such musicians may not draw much of an audience if they are not well known.

The Internet provides a relatively inexpensive alternative way for musicians to distribute their music. To do so, musicians may use a web page that, upon request, either or both distributes compact disks or tapes of their music to users, or allows users to select and download (or stream) their music. This distribution method also is limited, however, because potential listeners must find the particular musicians' web pages to access their music. Accordingly, if the musician is relatively obscure or new to the industry, their web page may have very few visitors.

A seemingly more effective way for musicians to widely distribute their music is across traditional and Internet-based radio stations. This method, however, is fraught with difficulties. Primarily, it is difficult (and possibly expensive) for a musician to have their music heard by the programming decision-maker of a radio station; namely, its programming director. More specifically, for a song to be played on the radio, a radio programming director first must listen to the song and make a wide variety of decisions that may include, among others, if the song is consistent with the format of the radio station, and if the song is good enough to play on the radio station. Accordingly, because of this function as the station “gate keeper,” programming directors typically receive many “demo tapes” on a daily basis. Unfortunately, experience has shown that because musicians send so many of them, program directors generally listen to few, if any, of the demo tapes they receive.

This problem is not unique to the music industry, which is discussed as an example only. For instance, artists are similarly challenged in reaching gallery owners, while writers may experience substantial difficulties in getting their books reviewed by anybody who makes publication decisions.

### SUMMARY OF THE INVENTION

In sum, at present, the problems with the distribution of media content may be summarized as the lack of direct access by creators of the media content (or others wishing to, for example promote the media content) to those persons in the particular industry that may effectively influence the distribution of the media content. Embodiments of the present invention may solve this problem by creating a systems and methods that allow artists to have access to individuals that have influence in the particular industry for which the media creator creates media content. In some embodiments, the media creator (or any other person seeking a review of the media content) may select one or more reviewers to review or otherwise comment on their media content.

Much of the discussion which follows may be directed to the music industry but that is by way of example only. The systems and methods disclosed herein are equally applicable to any type of media content and any industry related thereto.

A first embodiment of the present invention is directed to a method of allowing a user of a system to select a reviewer for at least one unit of media content. The method of this embodiment includes, after receiving from the user a request for a review, providing the user with information about a plurality of potential reviewers. The method of this embodiment may also include allowing the user to select at least one of the plurality of potential reviewers.

In one aspect of this embodiment, the plurality of potential reviewers includes one or more persons employed by a media distribution company. In one specific instance of this aspect, the one or more persons are involved in the music industry. In another specific instance of this aspect, the one or more persons is a programming director for a radio station. In another instance of the aspect the the one or more persons is an art critic.

In one aspect of this embodiment, the at least one unit of media content is music.

In one aspect of this embodiment, at least one of the potential reviewers must provide feedback to the user. In one specific instance of this embodiment the feedback includes a rating of the media content. In one specific instance of this embodiment the feedback is accessible by a member of the public and the user or may be accessible only by the user.

In one aspect of this embodiment, the method further includes the step of requiring the user to log in.

Another embodiment of the present invention is directed to a computer program product for use on a computer system for interactively allowing a user to select a reviewer for a unit of media content, the computer program product comprising a computer usable medium having computer readable program code thereon. The computer readable program code of this embodiment includes program code for presenting to the user, after the user has requested a review, a plurality of potential reviewers of the media content and program code for allowing the user to select at least one of the plurality of reviewers.

In one aspect of this embodiment the media content is music. In another aspect of this embodiment the media content is art work. In another aspect of this embodiment the media content is a book.

Another embodiment of the present invention is directed to a system for selecting a reviewer of media content. The system of this embodiment includes a central server arranged and configured to present to the user a plurality of potential reviewers of the media content after the user has requested a review, and to allow the user to select at least one of the plurality of reviewers. Aspects of this embodiment may include either a user access device or a reviewer access device, or both.

### BRIEF DESCRIPTION OF THE DRAWINGS

The foregoing features of the invention will be more readily understood by reference to the following detailed description, taken with reference to the accompanying drawings, in which:

FIG. 1 is an example of a system on which illustrative embodiments of the present invention may be implemented;

FIG. 2 shows a process of selecting a reviewer to review media content in accordance with one embodiment of the present invention;

FIG. 3 shows a media content review process according to an illustrative embodiment of the present invention;

FIG. 4 shows a process in which a reviewee may interact with the system to receive feedback from a reviewer in accordance with illustrative embodiments of the invention;

FIGS. 5A-5C are examples of screens which may be presented to reviewee;

FIG. 6 shows a process by which a selected reviewer (influencer) may provide feedback to a reviewee; and

FIGS. 7A-7C are examples of screens which may be presented to reviewer.

### DETAILED DESCRIPTION OF SPECIFIC EMBODIMENTS

Various embodiments of the present invention mitigate distribution problems for creators (or other persons) of media content. In one embodiment, a creator of media content selects the reviewer(s) to review the content. In a preferred embodiment, at least one of the reviewers is one of a group of persons who have influence in a particular industry. For example, a musician may pick reviewers from a group of radio station programming directors.

The following description will refer to a “creator” of media content seeking a review. Of course, others may also seek a review of the media content. Thus, the systems and methods disclosed herein may apply equally to anyone seeking a review of media content. Creators or non-creators will thus be referred to generally as “reviewees” or “users” herein.

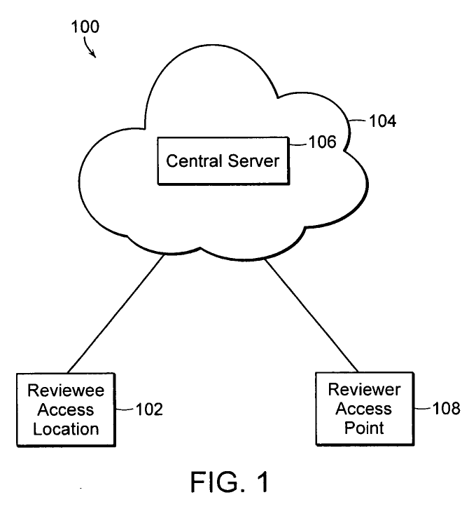

FIG. 1 is an example of a system 100 on which illustrative embodiments of the present invention may be implemented. This system is by way of example only and, thus, any system that allows a reviewee to select a reviewer for that media content should suffice. Among other things, the system enables the reviewee to select and transfer media content to the reviewer. To these ends, the system 100 includes a reviewee access device 102 that allows media content to be uploaded to another location. Examples include: a personal computer (desktop, laptop, etc.), a PDA, a cellular phone, or other electronic device. An exemplary reviewee access device 102 is a computer system, such as a laptop computer on which the disclosed invention can be implemented. The exemplary computer system is discussed for descriptive purposes only, however, and should not be considered a limitation of the invention. Although the description below may refer to terms commonly used in describing particular computer systems, the described concepts apply equally to other computer systems, including systems having architectures that are dissimilar to that described here.

The computer may include a central processing unit (CPU) having a conventional microprocessor, random access memory (RAM) for temporary storage of information, and read only memory (ROM) for permanent storage of read only information. A memory controller is provided for controlling system RAM.

Mass storage may be provided by known non-volatile storage media, such as a diskette, a digital versatile disk (not shown), a CD-ROM, or a hard disk. Data and software may be exchanged with the computer system via removable media, such as a diskette or a CD-ROM.

User input to the computer may be provided by a number of devices. For example, a keyboard and a mouse may be used. An audio transducer, which may act as both a microphone and a speaker, may also be used. It should be obvious to those reasonably skilled in the art that other input devices, such as a pen and/or tablet and a microphone for voice input, may be connected to computer. A direct memory access (DMA) controller is provided for performing direct memory access to system RAM. A visual display may be generated by a video controller, which controls a display device.

The computer system preferably is controlled and coordinated by operating system software. Among other computer system control functions, the operating system controls allocation of system resources and performs tasks such as process scheduling, memory management, networking, and I/O services.

A network adapter also may be included to enable the reviewee access device 102 to be interconnected to a network, such as the internet 104. The network, which may be a local area network (LAN), a wide area network (WAN), or the Internet, may utilize general purpose communication lines that interconnect a plurality of network devices. Preferably, the reviewee access device 102 includes internet connectivity for connecting to the internet 104.

The system 100 may also include a central server 106 that in some embodiments, stores media content submitted by the reviewee. In another embodiment, the central server 106 may store links to other locations where the media content is stored, such as the memory of the reviewee access device 102. In some embodiments, the central server 106 may also operate one or more web pages on the Internet. This web page may be accessible to the reviewee by selecting the address for that web page via the reviewee access device 102. As discussed in greater detail below, this web page may form, and be one illustrative embodiment of, a community by which the reviewee is allowed to select specific reviewers of the media content.

The system may also include a reviewer access location 108 that, in some embodiments may have the same or similar capabilities as the reviewee access device 102. Regardless, the reviewer access location 108 may allow the reviewer to receive media from the reviewee and to allow the reviewer to provide feedback about that media to the reviewee.

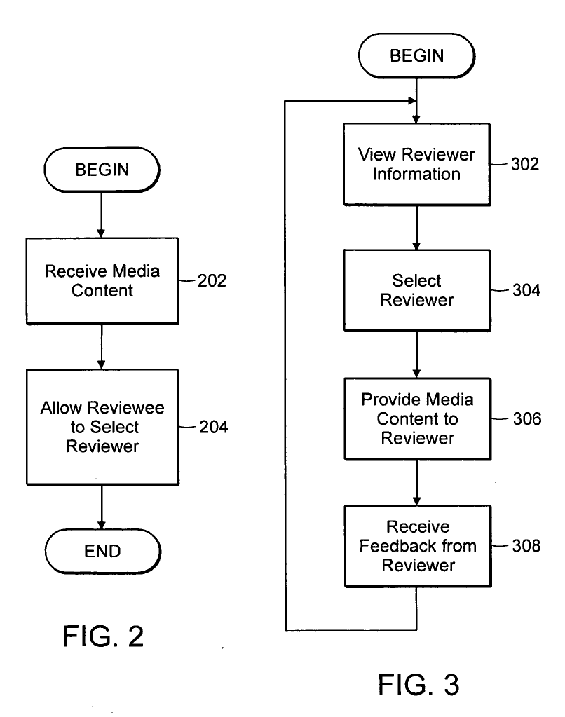

FIG. 2 shows a process of selecting a reviewer to review media content in accordance with one embodiment of the present invention. In this embodiment, media content is received from a reviewee at step 202. The method of this embodiment also includes a further step 204 wherein the reviewee is allowed to select a reviewer for the media content. As shown in FIG. 2, step 204 follows step 202. One of ordinary skill in the art will readily realize that the order of these steps may be reversed without departing from the spirit of the present invention.

FIG. 3 shows a media content of a review process according to an illustrative embodiment of the present invention. The review process shown in FIG. 3 may be applied to any type of media content. Regardless of the media content being reviewed, the process begins, in some embodiments, at step 302 where information about a particular reviewer may be viewed by the user. The information contained about the reviewer may include, for instance, an indication of the reviewer's expertise, including expertise in a particular industry, as well as a history of reviews given by the particular reviewer. The information about the reviewer may be stored on the central server 106 (FIG. 1) or at any other location accessible by the reviewee.

The process continues to step 304, in which the reviewee selects a reviewer The reviewer may be, in some preferred embodiments, a person having a standing or a position is able to influence content distribution decisions. For instance, and by way of example only, the reviewers of musical media content could be programming directors at radio stations.

The user may then provide the media content to the reviewer (step 306). This may be accomplished in a number of manners. For instance, the reviewee could upload the media content to the central server 106 (FIG. 1). The reviewer could then retrieve the content from the central server for review. Of course, there are many other ways in which the media content could be provided to the reviewer and, as should be readily recognized by those with skill in the art, any manner in which the media is provided to the reviewer is within the scope of the present invention. For example, the media content could be shown as a link to the reviewee's computer. In that case, the reviewer may select a link to access the media content on such computer. Additionally, the media content could be e-mailed to the reviewer or mailed on a disk. Alternatively, the reviewer could access the information from, for example, a central server, by calling into the server and having the media content played over the reviewer's phone.

Regardless of the method of transmission, after reviewing the media content, the reviewer may provide feedback to the reviewee (step 308). In certain embodiments of the invention, the feedback may be required for the reviewer to remain available for selection by future reviewees. In such a system, the feedback is, therefore, substantially guaranteed. This is substantially different from many prior art content review methods which, in most instances, do not review the content.

The feedback may be transmitted to the user in any manner. For instance, the reviewer could send an e-mail to the reviewee or the web page itself could have a specific section designated for each reviewee that is part of the system and the review may be posted to the section of individual who requested the review. Of course, there are many other manners in which the review may be transferred to the reviewee.

In some embodiments, the process shown in FIG. 3 may be repeated indefinitely for any number of reviews. Of course, the process could only be competed once or a limited number of times. In some embodiments, the feedback received by a particular reviewee may be stored in a location that is accessible by the reviewee only. In other embodiments, the feedback may also be available to the public. In fact, some embodiments may permit selected reviews to be accessible to the public. In another embodiment, the reviewee of the content may receive a grade or score from the reviewer. In such embodiments, the grade or score may be utilized to compare reviewees to one another. For instance, reviewees (or particular content creators) who receive the highest scores may be highlighted on a web page.

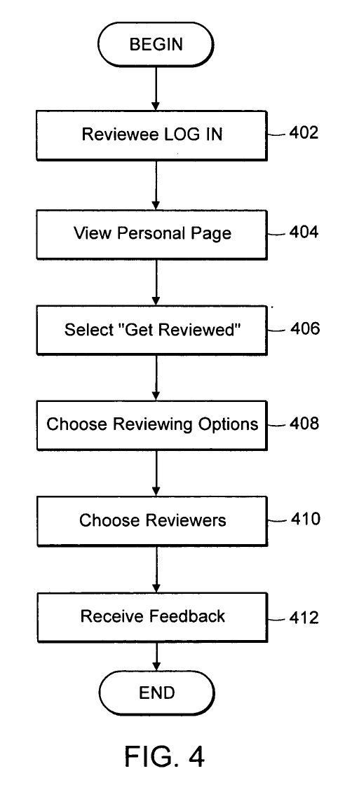

In some embodiments, both the reviewee and the reviewer may have a personal location on a web page maintained by the central server. That is, one or both of the reviewee and the reviewer may be able to log on to the web page and be allowed access to a portion of the web page that is specific to them. The following discussion related for FIGS. 4-7C describes an example of such a system and the user's interaction therewith.

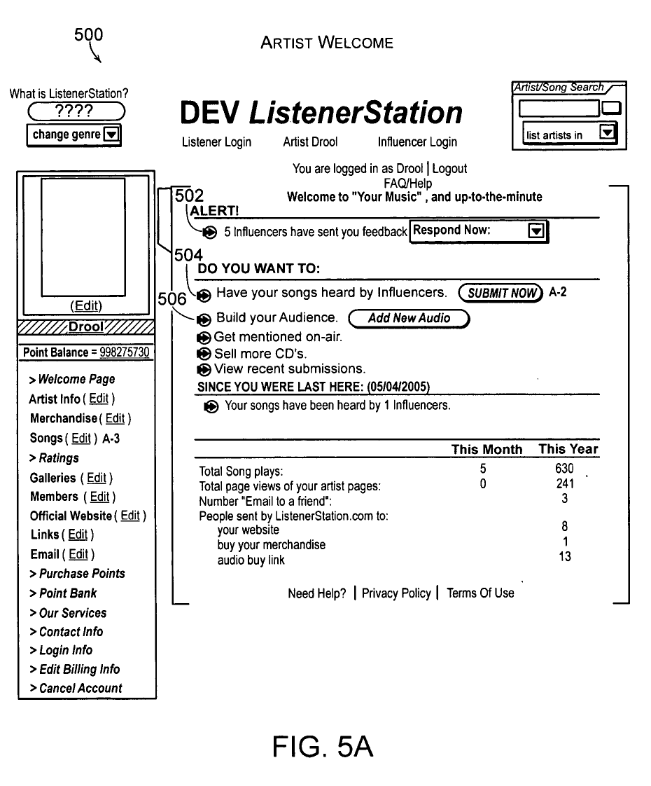

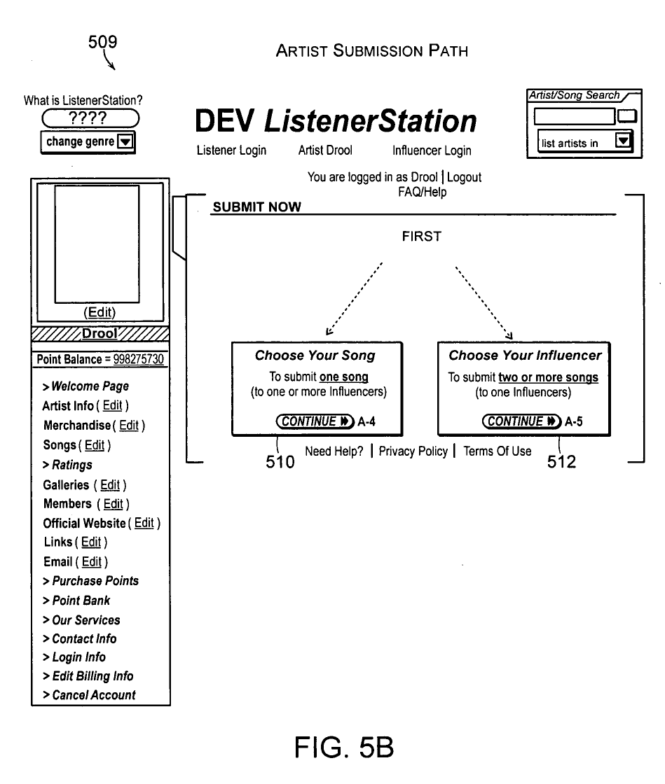

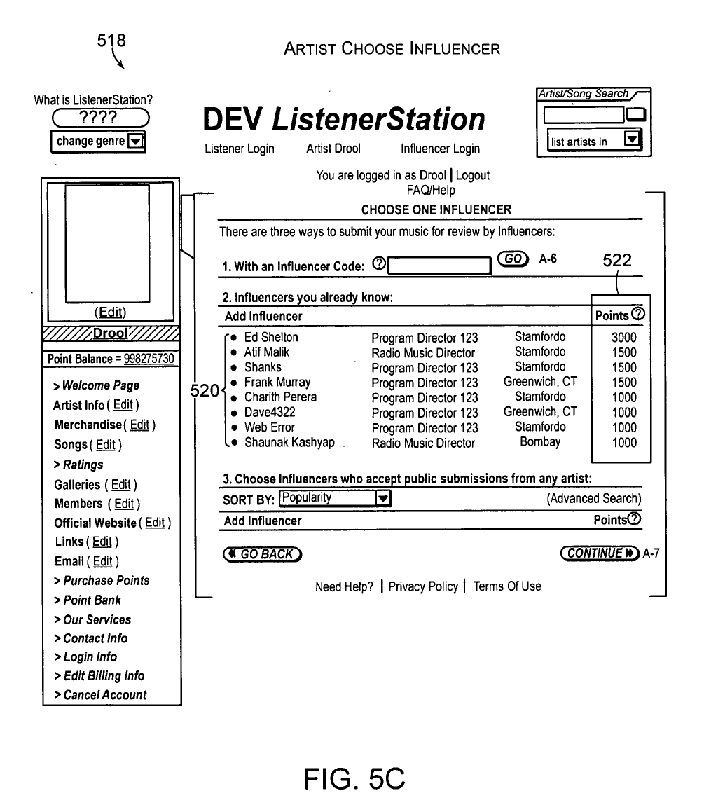

FIG. 4 shows a process in which a reviewee may interact with the system to receive feedback from a reviewer in accordance with illustrative embodiments of the invention. It should be understood that the process of FIG. 4 is by way of example only and steps contained therein may be omitted or additional steps added without departing from the present invention. In addition, the order of the steps in FIG. 4 is not limiting and the steps shown therein may be performed in a different order than that shown. The discussion of FIG. 4 also refers to FIGS. 5A-5C.

The process begins at step 402 where the reviewee is allowed to log in to the system. As one of ordinary skill should readily realize, the reviewee may accomplish this in any number of methods. For instance, the user could go to the general web page for the system and choose a “log-in” option, at which point a user name and password may be requested.

Following the log-in process of step 402, the reviewee may be presented with a personalized web page (or location) at step 404. An example of a personalized web page 500 for a reviewee is shown in FIG. 5A. The personalized web page may include several fields. For instance, the personalized web page 500 may include an alert field 502 that indicates that the reviewee has received a review of their media content from a reviewer.

As shown in FIG. 5A, a reviewer is referred to as an “influencer.” The terms reviewer and influencer may be used interchangeable herein.

The personalized web page 500 may also include a request review option 504 that allows a reviewee to have a song heard by an influencer. If the request reviewer option 504 is selected, the reviewee may then select at least one reviewer for a particular song. Of course, as noted above, the review of a song is by way of example only and any type of media content could be reviewed.

In some embodiments, the personalized web page 500 may have additional fields, such as an “add” field 506 which allows the reviewee to add additional media content to the web page. This may be accomplished in several ways. For example, the reviewee may upload the media to the web page or the reviewee may upload a link to the media content. Of course, media may also be added in other ways.

Referring back to FIG. 4, after viewing the personalized web page (step 404), the reviewee may select to have their media content reviewed at step 406 by, for example, selecting the request review option 504 (FIG. 5A). At step 408 the reviewee may then select reviewing options. For instance, and referring now to FIG. 5B, the system may present a screen 509 that allows the user to select to have either one song to be reviewed by one or more influencers by choosing a single song option 510 or to have two or more songs reviewed by one influencer by selecting a multiple song option 512. Of course, multiple songs could be reviewed by multiple reviewers.

Regardless of which option is selected, and referring back to FIG. 4, the reviewee may then select the reviewer(s) that will review their content (step 410). This may be accomplished, for example, by choosing the select reviewer option 512 on FIG. 5B. After making that selection, the reviewee may be presented with a screen 518 (FIG. 5C). In one embodiment, screen 518 may include a list of reviewers (influencers) 520 that are available to review the reviewee's media content. The list of influencers 520 may vary based on specific criteria. For instance, if the reviewee has a “heavy metal” song, the reviewee may wish to see only reviewers that work for radio stations that play heavy metal music. Regardless, the reviewee may be allowed to select one or more of the reviewers from the list 520.

In one embodiment, each reviewer may charge a cost in “points” to review a piece of media content. To that end, the list 520 may include a points column 522 that details how many points must be redeemed by the reviewee to have the media reviewed. In such an embodiment, the reviewee may obtain points from the operator or administrator of the central server 106 (FIG. 1). The points required for the review may then be deducted from the reviewees account when a review is requested. Of course, other forms of consideration could be utilized.

Referring again to FIG. 4, after the reviewer(s) of the media content are selected, the reviewee may then receive feedback from the reviewer. Examples of such feedback are described below.

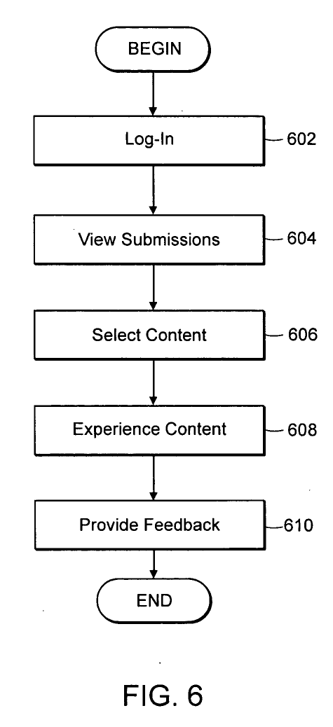

FIG. 6 shows a process by which a selected reviewer (influencer) may provide feedback to a reviewee. In some embodiments, the feedback may include a rating or grade for the media content. As discussed above, information about each reviewer may be presented to the reviewee. In a preferred embodiment, reviewers are from a select group that has influence regarding distribution of media content in the industry of interest for the reviewee.

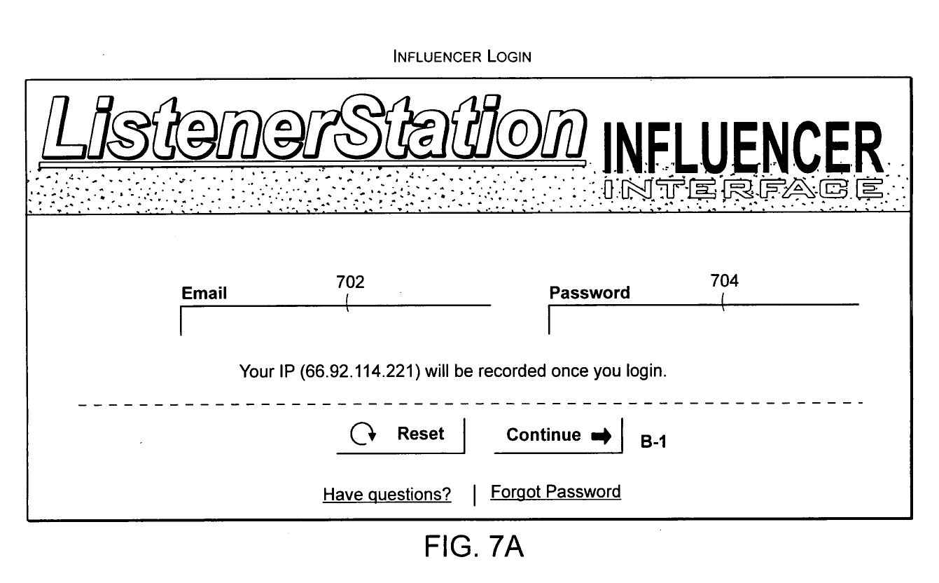

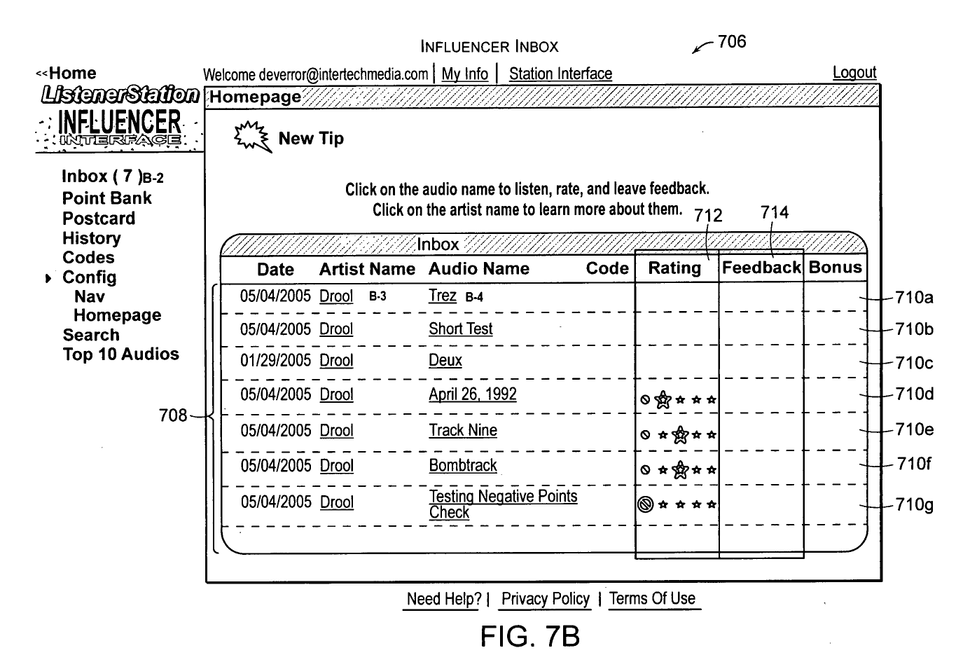

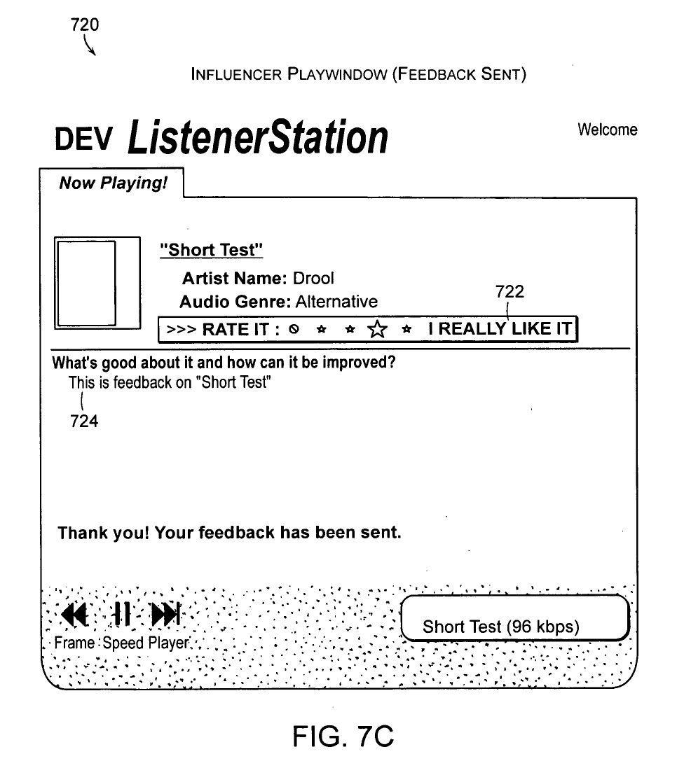

It should be understood that the flow chart of FIG. 6 is by way of example only and steps contained therein may be omitted or additional steps added without departing from the present invention. In addition, the order of the steps in FIG. 6 is not limiting and the steps shown therein may be performed in a different order than shown. The discussion of FIG. 6 will include references to FIGS. 7A-7C.

The process starts at step 602 where the reviewer logs into the system. An example of a log-in screen is shown in FIG. 7A. In some embodiments, the log-in screen may include input locations for a reviewer's identity 702 and their password 704. Of course, access to the system may not require a log-in and this step may be omitted or the method of logging in may be different than that shown herein.

The reviewer, at step 604, may then be provided with a listing of submissions to be reviewed. For example, and as shown by way of example in FIG. 7B, the reviewer may be presented with a screen 706, which includes a list of one or more in submissions 708 that the reviewer has been selected to review. As shown, the reviewer in this example has seven pieces of media content 710a-710g to review. In particular, media contents 710a-710c require both a rating and a feedback because there are no entries in the rating column 712 or the feedback column 714. The media contents 710d-710g, however, while having a rating, do not have an indication that feedback was presented.

At step 606, the reviewer selects a particular piece of media content to review. After the media content has been selected, the reviewer experiences the media content at step 608. The term “experience” as used herein refers to the act of reviewer interacting with the media content. For example, a reviewer may experience a song by listening to the song; a reviewer may experience a painting by viewing a picture of the painting; a reviewer may experience a motion picture by viewing the motion picture and simultaneously listening to accompanying audio; or a reviewer may experience a book by reading the book. These are just a few examples of how a reviewer may experience a piece of media content and are not meant as limiting.

After the reviewer has experienced the media content in step 608, the reviewer is allowed to provide feedback in step 610. In some embodiments, the feedback may include a rating of the media content. In other embodiments, the feedback may include written or oral or video review of the media content. In other embodiment, the feedback may include both a rating and a written or oral or video review of the media contents. In some embodiments, the reviewer may be required to provide immediate feedback while, in some instances, the feedback must be provided in a specific time period.

For example, FIG. 7C shows a screen 720 that includes both a rating 722 and written feedback 724. In some embodiments, after the reviewer has completed the review, the information contained therein is sent to the reviewee.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., WIFI, microwave, infrared or other transmission techniques). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

Although the above discussion discloses various exemplary embodiments of the invention, it should be apparent that those skilled in the art can make various modifications that will achieve some of the advantages of the invention without departing from the true scope of the invention.

What is claimed is:

1. A method for interactively obtaining reviews for media content, the method comprising:
receiving media content from a reviewee;
in response to a reviewee requesting a review, presenting to the reviewee a plurality of potential reviewers of the media content; and
allowing the reviewee to select at least one of the plurality of reviewers.

2. The method according to claim 1, wherein the plurality of potential reviewers includes one or more persons employed by a media distribution company.

3. The method of claim 2, wherein the one or more persons are involved in the music industry.

4. The method of claim 3, wherein the one or more persons is a programming director for a radio station.

5. The method of claim 2, wherein the one or more persons is an art critic.

6. The method of claim 1, wherein the media content is music.

7. The method of claim 1, wherein at least one of the potential reviewers must provide feedback to the reviewee.

8. The method of claim 7, wherein the feedback includes a rating of the media content.

9. The method of claim 7, wherein the feedback is accessible by a member of the public and the reviewee.

10. The method of claim 7, wherein the feedback is accessible only by the reviewee.

11. The method of claim 1, further comprising:
requiring the reviewee to provide log-in information.

12. A computer program product for use on a computer system for interactively obtaining reviews for media content, the computer program product comprising a computer usable medium having computer readable program code thereon, the computer readable program code comprising:
program code for receiving media content from a reviewee;
program code for presenting to the reviewee a plurality of potential reviewers of the media content, the program code for presenting being responsive to a reviewee request for a review; and
program code for allowing the reviewee to select at least one of the plurality of reviewers.

13. The computer program product of claim 12, wherein the media content is music.

14. The computer program product of claim 12, wherein the media content is art work.

15. The computer program product of claim 12, wherein the media content is a book.

16. The computer program product of claim 12, further comprising:
program code for allowing the reviewer to provide feedback to the reviewee.

17. The computer program product of claim 16, further comprising:
program code for allowing the reviewee to access the feedback.

18. A system for obtaining reviews of media content including:
a central server for receiving media content from a reviewee, the central server being arranged and configured to present to the reviewee a plurality of potential reviewers of the media content and to allow the reviewee to select at least one of the plurality of reviewers.

19. The system of claim 18 further comprising a reviewee access device.

20. The system of claim 19 further comprising a reviewer access device.
